(19) United States
(12) Patent Application Publication
(10) Pub. No.: US 2023/0094983 A1
(43) Pub. Date: Mar. 30, 2023

(54) VEHICLE MANAGEMENT SYSTEM AND STORE CONTROL DEVICE

(71) Applicant: TOYOTA JIDOSHA KABUSHIKI KAISHA, Toyota-shi Aichi-ken (JP)

(72) Inventor: Shojiro Suga, Nisshinn-shi Aichi-ken (JP)

(73) Assignee: TOYOTA JIDOSHA KABUSHIKI KAISHA, Toyota-shi Aichi-ken (JP)

(21) Appl. No.: 17/883,135

(22) Filed: Aug. 8, 2022

(30) Foreign Application Priority Data
Sep. 27, 2021 (JP) 2021-156505

(51) Int. Cl. G07C 5/00

(52) U.S. Cl. CPC G07C 5/006; G07C 5/008

(57) ABSTRACT

A vehicle management system includes an in-vehicle vehicle control device, a management server, and a store control device. The store control device is configured to transmit repair and replacement information to the vehicle control device when degraded part information is received from the management server. The repair and replacement information includes supply store information and a predetermined message indicating that a degraded part needs repair or replacement. The supply store information includes at least one energy supply store that is capable of repairing or replacing the degraded part and that is capable of supplying energy for travel to a vehicle on which the degraded part is mounted.

### CROSS-REFERENCE TO RELATED APPLICATION

This application claims priority to Japanese Patent Application No. 2021-156505 filed on Sep. 27, 2021, incorporated herein by reference in its entirety.

### BACKGROUND

### 1. Technical Field

The present disclosure relates to a vehicle management system and a store control device.

### 2. Description of Related Art

There has hitherto been proposed a vehicle management system in which a failure prediction server and a vehicle are connected to each other via a network (see Japanese Unexamined Patent Application Publication No. 2004-272375 (JP 2004-272375 A), for example). In this system, the failure prediction server predicts whether a failure will occur in the vehicle in the near future using vehicle data acquired in advance from the vehicle before the occurrence of a failure, and reports to a customer of the target vehicle when a failure is predicted.

### SUMMARY

While the system discussed above reports to the customer of the target vehicle when a failure of a part etc. of the vehicle is predicted, there are a large number of customers of the target vehicle who think that it is not necessary to have the vehicle maintained when there is no trouble with travel. Therefore, the vehicle may not be maintained appropriately.

The present disclosure provides a vehicle management system and a store control device that allow a vehicle to be maintained more adequately.

A first aspect of the present disclosure provides a vehicle management system including: a vehicle control device configured to communicate via a communication network, the vehicle control device being an in-vehicle vehicle control device; a management server configured to communicate via the communication network; and a store control device configured to communicate via the communication network. The vehicle control device is configured to transmit vehicle information to the management server at intervals of a predetermined period, the vehicle information including vehicle identification information and vehicle use information about use of a vehicle. The management server is configured to make a degradation determination for determining a degree of degradation of a part of the vehicle based on the vehicle information received from the vehicle control device, and to transmit degraded part information to the store control device when determination is made in the degradation determination that the part of the vehicle has been degraded to a predetermined degree, the degraded part information including information on the degraded part and the vehicle identification information on the vehicle on which the part is mounted. The store control device is configured to transmit repair and replacement information to the vehicle control device when the degraded part information is received from the management server, the repair and replacement information including supply store information and a predetermined message indicating that the degraded part needs repair or replacement, and the supply store information including at least one energy supply store that is able to repair or replace the degraded part and that is able to supply energy for travel to the vehicle on which the degraded part is mounted.

With such a configuration, it is possible to suggest that the vehicle user should request the energy supply store to repair or replace the part during energy supply. As a result, the vehicle can be maintained more adequately. The energy supply store may be a gas station, a hydrogen station, a charging station, etc. Examples of the predetermined message include “A part needs repair or replacement. Please visit the store displayed.”

The vehicle management system according to the above first aspect may be configured to further include a supply store control device disposed at the energy supply store and communicable via the communication network. The store control device may be configured to receive a work reservation from a vehicle user, the work reservation including a choice of an energy supply store at which the part is to be repaired or replaced based on the repair and replacement information, and to transmit degraded part information related to the work reservation to the supply store control device at the energy supply store related to the work reservation when the work reservation is received. With such a configuration, it is possible to inform the energy supply store of information on the degraded part together with information about the vehicle user when a work reservation is made, allowing the subsequent maintenance such as repair or replacement of the part to be performed well. In the vehicle management system according to the above first aspect, the store control device may be configured to perform a process of shipping the part related to the work reservation to the energy supply store related to the work reservation when the work reservation is received. With such a configuration, it is possible to smoothly ship the part related to the work reservation to the energy supply store. Examples of the shipping process include a process of outputting a shipping form that indicates the part related to the work reservation and the energy supply store as the shipping destination.

In the vehicle management system according to the above first aspect, the vehicle control device may be configured to transmit used supply store information about energy supply stores at which the vehicle was supplied with energy for travel previously to the store control device directly or by way of the management server; and the store control device may be configured to specify an energy supply store that was frequently used based on the used supply store information, and to output the repair and replacement information to the specified energy supply store. With such a configuration, it is possible to suggest that the part should be maintained, e.g., repaired or replaced, during energy supply at the energy supply store that is frequently used by the vehicle user.

In the vehicle management system according to the above first aspect, the supply store control device may be configured to apply a discounted price when the vehicle is supplied with energy along with repair or replacement of the part related to the work reservation, compared to when the vehicle is supplied with energy without repair or replacement of the part related to the work reservation. With such a configuration, it is possible to offer the vehicle user an advantage of having the vehicle maintained, promoting the maintenance of the vehicle better.

In the vehicle management system according to the above first aspect, the vehicle control device may be configured to transmit remaining amount information about a remaining amount of energy for travel to the store control device directly or by way of the management server; and the store control device may be configured to transmit information to the vehicle control device when the remaining amount of energy has become equal to or less than a predetermined remaining amount based on the remaining amount information, the information including a message that suggests repair or replacement of the degraded part. With such a configuration, it is possible to suggest that the vehicle user should have the part maintained, e.g., repaired or replaced, when the vehicle is supplied with energy. In the vehicle management system according to the above first aspect, the store control device may be configured to transmit information to the vehicle control device when a time required for energy supply at the energy supply store based on the remaining amount information has become equal to or more than a time required to repair or replace the part related to a work reservation, the information including a message that suggests repair or replacement of the degraded part. With such a configuration, it is possible to have the part maintained, e.g., repaired or replaced, while energy is supplied at the energy supply store, promoting the maintenance of the vehicle better.

A second aspect of the present disclosure provides a vehicle management system including: a vehicle control device communicable via a communication network, the vehicle control device being an in-vehicle vehicle control device; a management server communicable via the communication network; and a store control device communicable via the communication network.

The vehicle control device is configured to transmit vehicle information to the management server at intervals of a predetermined period, the vehicle information including vehicle identification information and vehicle use information about use of a vehicle, and to transmit remaining amount information about a remaining amount of energy for travel to the store control device directly or by way of the management server. The management server is configured to make a degradation determination for determining a degree of degradation of a part of the vehicle based on the vehicle information received from the vehicle control device, and to transmit degraded part information to the store control device when determination is made in the degradation determination that the part of the vehicle has been degraded to a predetermined degree, the degraded part information including information on the degraded part and the vehicle identification information on the vehicle on which the part is mounted.
The store control device is configured to transmit repair and replacement information to the vehicle control device when the degraded part information is received from the management server, the repair and replacement information including supply store information and a predetermined message indicating that the degraded part needs repair or replacement, and the supply store information including at least one energy supply store that is able to repair or replace the degraded part and that is able to supply energy for travel to the vehicle on which the degraded part is mounted. The store control device is configured to transmit the repair and replacement information when a time required for energy supply at the energy supply store based on the remaining amount information has become equal to or more than a time required to repair or replace the degraded part.

With such a configuration, it is possible to inform the vehicle user that the vehicle user can have the part maintained, e.g., repaired or replaced, while energy is supplied at the energy supply store, promoting the maintenance of the vehicle better.

A third aspect of the present disclosure provides a store control device including a communication device configured to communicate with an outside of the store control device via a communication network. The communication device is configured to receive degraded part information from the outside of the store control device, and to transmit repair and replacement information to a vehicle, the repair and replacement information including supply store information and a predetermined message indicating that a degraded part needs repair or replacement, and the supply store information including at least one energy supply store that is able to repair or replace the degraded part and that is able to supply energy for travel to the vehicle on which the degraded part is mounted.

The store control device according to the above third aspect may be configured to communicate with a vehicle control device and a management server via a communication network, the vehicle control device being an in-vehicle vehicle control device. The vehicle control device may be configured to transmit vehicle information to the management server at intervals of a predetermined period, the vehicle information including vehicle identification information and vehicle use information about use of the vehicle. The management server may be configured to make a degradation determination for determining a degree of degradation of a part of the vehicle based on the vehicle information, and to transmit degraded part information to the store control device when determination is made in the degradation determination that the part of the vehicle has been degraded to a predetermined degree, the degraded part information including information on the degraded part and the vehicle identification information on the vehicle on which the part is mounted.

With such a configuration, it is possible to suggest that the vehicle user should request the energy supply store to repair or replace the part during energy supply of the vehicle. As a result, the vehicle can be maintained more adequately. The energy supply store may be a gas station, a hydrogen station, a charging station, etc. Examples of the predetermined message include “A part needs repair or replacement. Please visit the store displayed.”

The store control device according to the above third aspect may be configured to communicate with a supply store control device disposed at the energy supply store. The store control device may be configured to receive a work reservation from a vehicle user, the work reservation including a choice of an energy supply store at which the part is to be repaired or replaced based on the repair and replacement information, and to transmit degraded part information related to the work reservation to the supply store control device at the energy supply store related to the work reservation when the work reservation is received. With such a configuration, it is possible to inform the energy supply store of information on the degraded part together with information about the vehicle user when a work reservation is made, allowing the subsequent maintenance such as repair or replacement of the part to be performed well.

In the store control device according to the above third aspect, the vehicle control device may be configured to transmit used supply store information about energy supply stores at which the vehicle was supplied with energy for travel previously to the store control device directly or by way of the management server; and the store control device may be configured to specify an energy supply store that was frequently used based on the used supply store information, and to output the repair and replacement information to the specified energy supply store. With such a configuration, it is possible to suggest that the part should be maintained, e.g., repaired or replaced, during energy supply at the energy supply store that is frequently used by the vehicle user.

In the store control device according to the above third aspect, the vehicle control device may be configured to transmit remaining amount information about a remaining amount of energy for travel to the store control device directly or by way of the management server; and the store control device may be configured to transmit information to the vehicle control device when the remaining amount of energy has become equal to or less than a predetermined remaining amount based on the remaining amount information, the information including a message that suggests repair or replacement of the degraded part. With such a configuration, it is possible to suggest that the vehicle user should have the part maintained, e.g., repaired or replaced, when the vehicle is supplied with energy. The store control device according to the above third aspect may be configured to transmit information to the vehicle control device when a time needed to supply the remaining amount of energy based on the remaining amount information has become equal to or more than a time required to repair or replace the part related to a work reservation, the information including a message that suggests repair or replacement of the degraded part. With such a configuration, it is possible to inform the vehicle user that the vehicle user can have the part maintained, e.g., repaired or replaced, while energy is supplied at the energy supply store, promoting the maintenance of the vehicle better.

A fourth aspect of the present disclosure provides a store control device configured to communicate with a vehicle control device and a management server via a communication network, the vehicle control device being an in-vehicle vehicle control device.

The vehicle control device is configured to transmit vehicle information to the management server at intervals of a predetermined period, the vehicle information including vehicle identification information and vehicle use information about use of a vehicle, and to transmit remaining amount information about a remaining amount of energy for travel to the store control device directly or by way of the management server. The management server is configured to make a degradation determination for determining a degree of degradation of a part of the vehicle based on the vehicle information, and to transmit degraded part information to the store control device when determination is made in the degradation determination that the part of the vehicle has been degraded to a predetermined degree, the degraded part information including information on the degraded part and the vehicle identification information related to the part.
The store control device includes a communication device communicable with an outside via the communication network, and is configured to transmit repair and replacement information to the vehicle control device when the degraded part information is received and when a time required for energy supply at an energy supply store based on the remaining amount information has become equal to or more than a time required to repair or replace the degraded part, the repair and replacement information including supply store information and a predetermined message indicating that the degraded part needs repair or replacement, and the supply store information including at least one energy supply store that is able to repair or replace the degraded part and that is able to supply energy for travel to the vehicle on which the degraded part is mounted.

With such a configuration, it is possible to suggest that the vehicle user should request the energy supply store to repair or replace the part during energy supply of the vehicle. Further, it is possible to inform the vehicle user that the vehicle user can have the part maintained, e.g., repaired or replaced, while energy is supplied at the energy supply store, promoting the maintenance of the vehicle better.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a schematic configuration of a vehicle management system 10 according to an embodiment of the present disclosure;

FIG. 2 is a diagram illustrating a schematic configuration of an automobile 20 in the vehicle management system 10 according to the embodiment;

FIG. 3 is a schematic diagram schematically illustrating processes to be performed when a part of the automobile 20 has been degraded to such a degree that the part needs repair or replacement;

FIG. 4 is a flowchart illustrating an example of a vehicle information transmission process executed by an electronic control unit 30 mounted on the automobile 20;

FIG. 5 is a flowchart illustrating an example of a degradation determination process executed by a management server 120;

FIG. 6 is a flowchart illustrating an example of a repair notification shipping process executed by a store computer 220;

FIG. 7 is a flowchart illustrating an example of a reservation reception process executed by the store computer 220;

FIG. 8 is a flowchart illustrating an example of a notification process executed by the store computer 220; and

FIG. 9 is a flowchart illustrating an example of a payment process executed by a refueling station computer 320.

### DETAILED DESCRIPTION OF EMBODIMENTS

Now, a mode for carrying out the present disclosure will be described with reference to an embodiment.

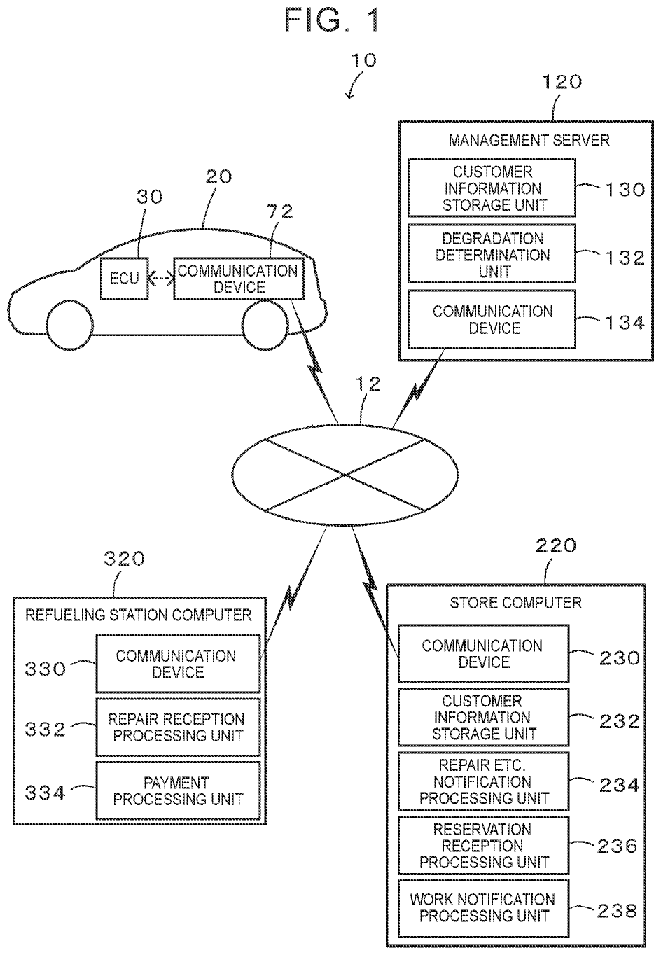

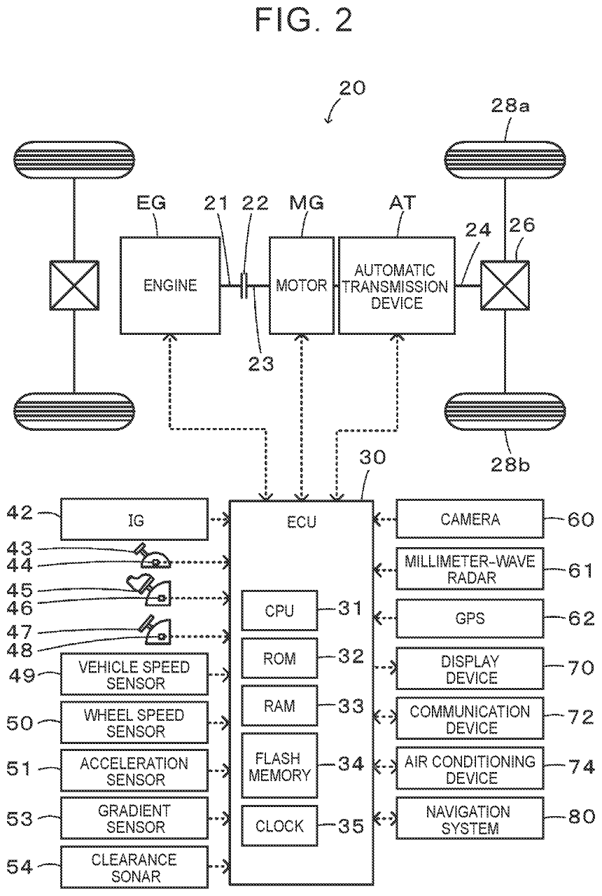

FIG. 1 is a diagram illustrating a schematic configuration of a vehicle management system 10 according to an embodiment of the present disclosure. FIG. 2 is a diagram illustrating a schematic configuration of an automobile 20 in the vehicle management system 10 according to the embodiment. As illustrated in the drawings, the vehicle management system 10 according to the embodiment includes an electronic control unit 30 mounted on the automobile 20 and communicably connected through a network 12, a management server 120 disposed at a vehicle management center, a store computer 220 installed at each dealer, and a refueling station computer 320 installed at a plurality of gas stations. In this embodiment, the gas station is taken as an example of the energy supply store, but the energy supply store may be a hydrogen station, a charging station, etc.

As illustrated in FIG. 2, the automobile 20 includes an engine EG, a motor MG, and an automatic transmission device AT. The engine EG is constituted as an internal combustion engine driven using hydrocarbon fuel such as gasoline or light oil, for example. An output shaft 21 of the engine EG is connected to an input shaft 23 of the automatic transmission device AT via a clutch 22. The motor MG is constituted as a synchronous motor generator, for example. A rotor of the motor MG is connected to the input shaft 23 of the automatic transmission device AT. The motor MG is driven by converting direct-current power from a battery (not illustrated) into three-phase alternating-current power using an inverter (not illustrated) and applying the three-phase alternating-current power to the motor MG. The automatic transmission device AT is constituted as a hydraulically driven transmission with six forward speeds and one reverse speed and composed of a torque converter and an automatic transmission, for example. A drive shaft 24 which is an output shaft of the automatic transmission device AT is coupled to drive wheels 28a, 28b via a differential gear 26.

The automobile 20 includes various sensors such as a vehicle speed sensor 49, a wheel speed sensor 50, an acceleration sensor 51, a yaw rate sensor 52, a gradient sensor 53, and a clearance sonar 54, cameras 60, a millimeter-wave radar 61, a global positioning system (GPS) 62, a display device 70, a communication device 72, an air conditioning device 74 for air conditioning of an occupant cabin, a navigation system 80, and the electronic control unit 30.

Multiple cameras 60 are disposed so as to be able to image the front side, the rear side, and the lateral sides of the vehicle. The communication device 72 communicates with the management server 120 via a wireless communication network, and receives various kinds of information via the Internet. The air conditioning device 74 conditions air in the vehicle cabin.

The navigation system 80 guides the vehicle to a set destination, and includes a map information database and a display unit (not illustrated). The map information database stores, as map information, the state of pavement of the road surface of roads in each section, the width of the roads, the number of lanes, the width of sidewalks, the direction in which vehicles can travel, the legal speed, etc. When a destination is set, the navigation system 80 sets a route based on information on the destination, information on the present location (the present position of the vehicle) acquired through the GPS 62, and information stored in the map information database, and provides route guidance.

The electronic control unit 30 is a microcomputer constituted to include a central processing unit (CPU) 31 as a central component, and includes a read only memory (ROM) 32 that stores a program etc., a random access memory (RAM) 33 that temporarily stores data, a flash memory 34 that stores data etc., a clock 35 that provides a timer function, and input and output ports (not illustrated), besides the CPU 31.

Signals from the various sensors are input to the electronic control unit 30 via the input port. The signals input to the electronic control unit 30 via the input port may include an ignition signal from an ignition switch 42, a shift position SP from a shift position sensor 44 that detects the position of a shift lever 43, an accelerator operation amount Acc from an accelerator pedal position sensor 46 that detects the amount of depression of an accelerator pedal 45, a brake position BP from a brake pedal position sensor 48 that detects the amount of depression of a brake pedal 47, etc. The signals may also include a vehicle speed V from the vehicle speed sensor 49, a wheel speed Vw from the wheel speed sensor 50, a front-rear acceleration α1 and a lateral acceleration α2 from the acceleration sensor 51, a road surface gradient θ from the gradient sensor 53, proximity information from the clearance sonar 54, radar information from the millimeter-wave radar 61, GPS data (position information) from the GPS 62, etc. The signals may further include signals that indicate the state of the engine EG from various sensors attached to the engine EG.

Various control signals are output from the electronic control unit 30 via the output port. The control signals output from the electronic control unit 30 via the output port may include a display control signal for the display device 70, a communication control signal for the communication device 72, an air conditioning control signal for the air conditioning device 74, etc. The control signals may also include a throttle control signal for controlling operation of the engine EG, control signals such as a fuel injection control signal and an ignition control signal, etc.

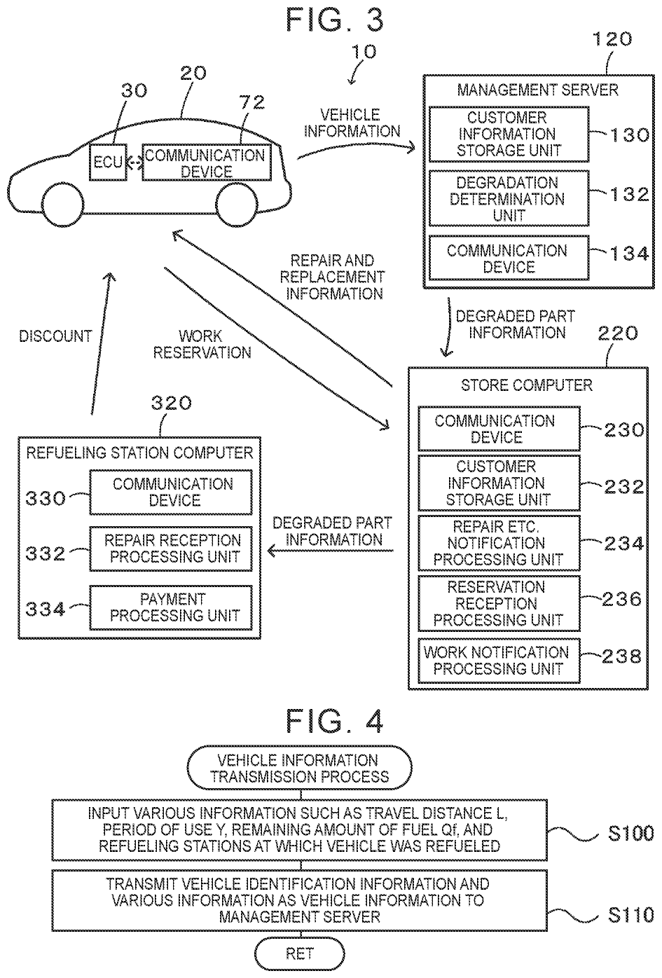

As illustrated in FIG. 3, the management server 120 includes a customer information storage unit 130 that stores customer information to be used for user authentication etc., vehicle information to be discussed later, etc., a degradation determination unit 132 that determines degradation of a part of the vehicle, and a communication device 134. The degradation determination unit 132 is a functional block implemented through computation processing by the management server 120. The customer information storage unit 130 stores, for each vehicle, vehicle identification information, vehicle configuration data such as vehicle model, type, and parts, customer data such as customer name and customer address, the dealer that sold the vehicle, failure-related data such as failures that occurred previously and the content of repair for such failures, etc. The degradation determination unit 132 determines, for a consumable part that constitutes the vehicle, whether the part has been degraded to such a degree that the part needs repair, replacement, etc. based on the period of use and the travel distance.

The store computer 220 includes a communication device 230, a customer information storage unit 232, a repair etc. notification processing unit 234, a reservation reception processing unit 236, and a work notification processing unit 238. The repair etc. notification processing unit 234, the reservation reception processing unit 236, and the work notification processing unit 238 are each a functional block implemented through computation processing by the store computer 220. The customer information storage unit 232 stores customer data such as customer name and customer address, vehicle identification information, vehicle configuration data such as vehicle model, type, and parts, failure-related data such as failures that occurred previously and the content of repair for such failures, etc. The repair etc. notification processing unit 234 performs, when determination is made that a part of the vehicle has been degraded to such a degree that the part needs repair or replacement, a process of notifying of a refueling station that can repair or replace the part, notifying that the part needs repair or replacement, and transmitting information on the part etc. to the refueling station. The reservation reception processing unit 236 performs a process of receiving a work reservation for repair or replacement of the degraded part from a user of the vehicle based on the notification of the repair and replacement information. The work notification processing unit 238 performs a notification process of suggesting that the vehicle user should have the degraded part repaired or replaced.

The refueling station computer 320 includes a communication device 330, a repair reception processing unit 332, and a payment processing unit 334. The repair reception processing unit 332 and the payment processing unit 334 are each a functional block implemented through computation processing by the refueling station computer 320. The repair reception processing unit 332 performs a process of receiving information on a part that needs repair or replacement etc. transmitted from the store computer 220, and receiving shipping information on the part. The payment processing unit 334 performs a process of calculating a refueling fee, a fee for maintenance such as repair or replacement of a part, and a discount on the refueling fee for the performance of maintenance.

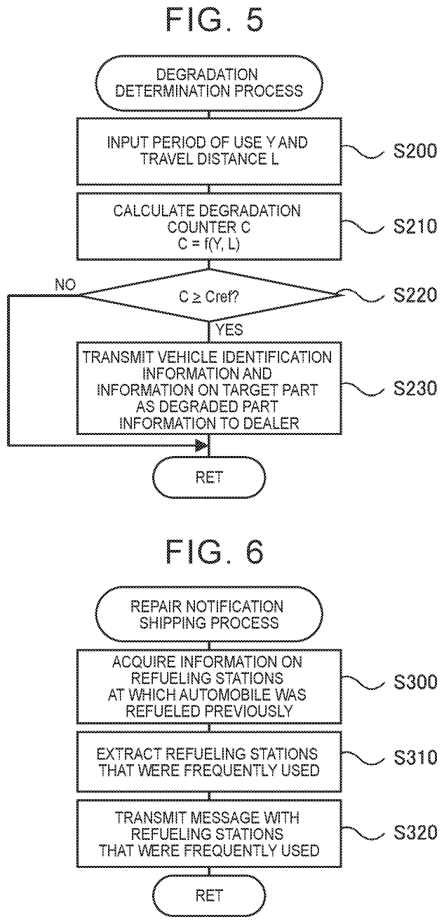

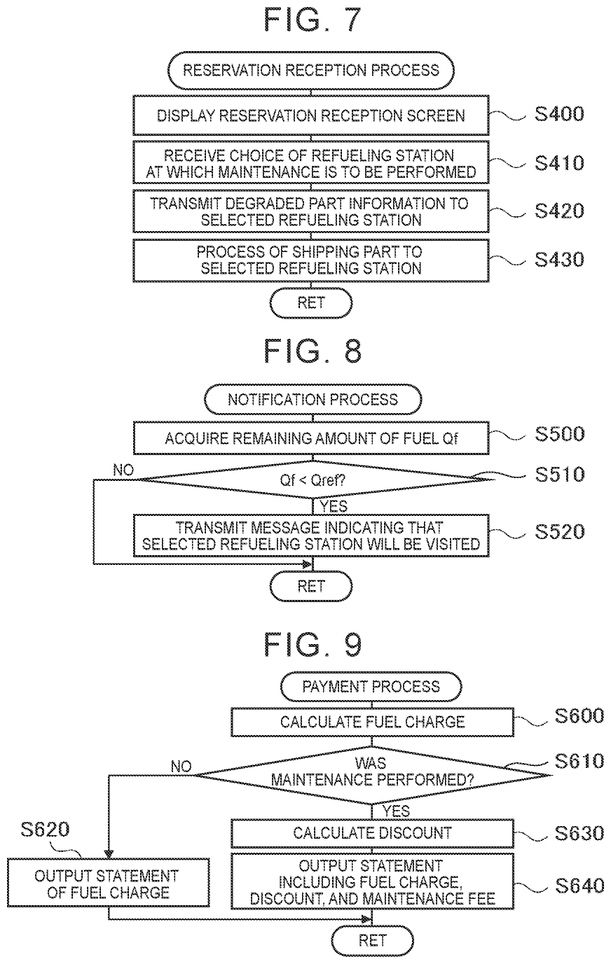

FIG. 3 is a schematic diagram schematically illustrating processes to be performed when a part of the automobile 20 has been degraded to such a degree that the part needs repair or replacement. The processes will be described below with reference to the schematic diagram and the flowcharts of the processes in FIGS. 4 to 9. FIG. 4 is a flowchart illustrating an example of a vehicle information transmission process executed by the electronic control unit 30 mounted on the automobile 20. FIG. 5 is a flowchart illustrating an example of a degradation determination process executed by the management server 120. FIG. 6 is a flowchart illustrating an example of a repair notification shipping process executed by the store computer 220. FIG. 7 is a flowchart illustrating an example of a reservation reception process executed by the store computer 220. FIG. 8 is a flowchart illustrating an example of a notification process executed by the store computer 220. FIG. 9 is a flowchart illustrating an example of a payment process executed by the refueling station computer 320. The processes will be sequentially described below.

The vehicle information transmission process in FIG. 4 is repeatedly executed by the electronic control unit 30 at intervals of a predetermined time after the system of the automobile 20 is started. In the vehicle information transmission process, a travel distance L, a period of use Y, a remaining amount of fuel Qf, and information on refueling stations at which the vehicle was refueled during the repeated process are input (step S100), besides general information on the vehicle state such as the present position, vehicle speed, and acceleration. The various kinds of input information are transmitted as vehicle information to the management server 120 together with vehicle identification information (step S110), and the present process is ended. When the vehicle information is received, the management server 120 stores the various kinds of information in the customer information storage unit 130 in association with the vehicle identification information.

The degradation determination process in FIG. 5 is performed by the degradation determination unit 132 as a functional block of the management server 120. This process is repeatedly executed for a part that needs a degradation determination to be made at intervals of a predetermined period. For example, the process is repeatedly executed for a part that needs a degradation determination to be made each time the period of use Y is increased by a predetermined period (e.g., 0.5 years, 1 year, etc.) or each time the travel distance L is increased by a predetermined distance (e.g., 500 km, 1000 km, etc.). In the degradation determination process, first, a period of use Y and a travel distance L of the target vehicle are input (step S200), and a degradation counter C is calculated based on the period of use Y and the travel distance L (step S210). The degradation counter C is calculated so as to become larger as the period of use Y becomes longer and as the travel distance L becomes longer. It is determined whether the calculated degradation counter C has become equal to or more than a degradation determination threshold Cref (step S220). The degradation determination threshold Cref is set, based on the service life etc. of the part, as a value at which the part is considered to need repair or replacement because of the period of use or the travel distance. The degradation determination threshold Cref is occasionally set to be smaller than normally when the automobile 20 has a history of colliding or the like. When determination is made that the degradation counter C is less than the degradation determination threshold Cref, it is determined that the target part has not been degraded to such a degree that the part needs repair or replacement, and the present process is ended. When determination is made that the degradation counter C is equal to or more than the degradation determination threshold Cref, on the other hand, it is determined that the target part has been degraded to such a degree that the part needs repair or replacement. The vehicle identification information on the vehicle 20 on which the degraded target part is mounted and part information on the target part are transmitted as degraded part information to the store computer 220 at the dealer that sold the automobile 20 (step S230), and the present process is ended. When the degraded part information is received, the store computer 220 stores the part information in the customer information storage unit 232 in association with the vehicle identification information.

The repair etc. notification process in FIG. 6 is performed by the repair etc. notification processing unit 234 as a functional block of the store computer 220. This process is executed when the degraded part information is received from the management server 120. In the repair etc. notification process, first, information on refueling stations at which the automobile 20 was refueled previously is acquired from the management server 120 using the vehicle identification information included in the degraded part information (step S300). Subsequently, refueling stations that were frequently used are extracted from among the refueling stations at which the automobile 20 was refueled previously (step S310). In this case, a refueling station that was most frequently used may be extracted, or multiple (e.g., two or three) refueling stations that were frequently used may be extracted in the descending order of the frequency of use. A message that includes information on the extracted refueling stations and that suggests maintenance such as repair or replacement of the part is transmitted as repair and replacement information to the electronic control unit 30 of the automobile 20 (step S320), and the present process is ended. Examples of the message include “A part of the vehicle has been degraded. You can have the part repaired or replaced at the following refueling stations. Make a reservation for smooth work.” When the repair and replacement information is received, the electronic control unit 30 of the automobile 20 displays the information on the refueling stations and the message on the display device 70. Consequently, the vehicle user can be informed that the part of the vehicle needs repair or replacement and that the repair or replacement can be performed at the refueling stations displayed, suggesting that the vehicle user should make a reservation.

The reservation reception process in FIG. 7 is performed by the reservation reception processing unit 236 as a functional block of the store computer 220. In the reservation reception process, a control signal for displaying a reservation reception screen (not illustrated) on the display device 70 of the automobile 20 is transmitted (step S400). In embodiments, the reservation reception screen displays a list of the names of the refueling stations extracted as refueling stations that were frequently used, and allows selecting one of the refueling stations. When a refueling station is selected on the reservation reception screen by the vehicle user, a choice of a refueling station at which maintenance is to be performed is received (step S410). The degraded part information is transmitted to the refueling station computer 320 at the selected refueling station (step S420). A shipping process of shipping a part to the selected refueling station is performed (step S430), and the present process is ended. When the degraded part information is received, the refueling station computer 320 stores the degraded part information (vehicle identification information and part information) in the repair reception processing unit 332 as a functional block. The shipping process may be a process of requesting a part manufacturer to ship the part.

The notification process in FIG. 8 is performed by the work notification processing unit 238 as a functional block of the store computer 220. The notification process is repeatedly executed at intervals of a predetermined time. In the notification process, first, the remaining amount of fuel Qf of the automobile 20 is acquired from the management server 120 (step S500), and determination is made whether the remaining amount of fuel Qf has become less than a notification determination threshold Qref (step S510). While the notification determination threshold Qref may be a remaining amount of fuel determined in advance as a remaining amount of fuel with which it takes a certain time to refuel the automobile 20, the notification determination threshold Qref, in embodiments, is a remaining amount of fuel with which the time required for refueling is equal to or more than the time required to repair or replace the part. This is to suppress the vehicle user waiting for a longer time than the time required for refueling, as repair or replacement of the part is finished within the time required for refueling when the part is to be repaired or replaced during refueling. When determination is made that the remaining amount of fuel Qf is equal to or more than the notification determination threshold Qref, it is determined that it is still not the time to make a notification, and the present process is ended. When determination is made that the remaining amount of fuel Qf is less than the notification determination threshold Qref, on the other hand, a message indicating that refueling and repair or replacement of the part are to be performed at the selected refueling station is transmitted to the electronic control unit 30 of the automobile 20 (step S520), and the present process is ended. Examples of the message include “Refuel the vehicle at the selected refueling station. You can have the part repaired or replaced during the time needed for refueling. The fuel charge will be discounted if you have the part maintained during refueling.” When such a message is received, the electronic control unit 30 of the automobile 20 can suggest that the vehicle user should have the vehicle refueled and have the part repaired or replaced at the selected refueling station, by displaying the message on the display device 70.

The payment process in FIG. 9 is performed by the payment processing unit 334 as a functional block of the refueling station computer 320. The payment process is executed when refueling of the automobile 20 and repair or replacement of the part are completed. In the payment process, first, a fuel charge is calculated (step S600). This calculation can be made by multiplying the unit price of the fuel by the amount of fuel supplied. Subsequently, determination is made whether maintenance such as repair or replacement of the part was performed (step S610). Determination can be made whether maintenance was performed, by inputting work when the part is repaired or replaced and checking the presence or absence of such input. When determination is made that maintenance was not performed, a statement of the fuel charge is output (step S620), and the present process is ended. When determination is made that maintenance was performed, on the other hand, a discount on the fuel charge is calculated (step S630), a statement including the fuel charge, the discount, and the maintenance fee (fee for the repair or replacement of the part) is output (step S640), and the present process is ended. The discount may be calculated as several percent of the fuel charge, for example. By repairing or replacing the part along with refueling in this manner, it is possible to suggest that the vehicle user should have the degraded part repaired or replaced during refueling, by providing a discount on the fuel charge.

In the vehicle management system 10 according to the embodiment described above, the electronic control unit 30 of the automobile 20 transmits vehicle information to the management server 120 at intervals of a predetermined time. The management server 120 uses the degradation counter C which is based on the period of use Y and the travel distance L to make a degradation determination as to whether the target part has been degraded to such a degree that the part needs repair or replacement. When determination is made that the part has been degraded to such a degree that the part needs repair or replacement, the management server 120 transmits the vehicle identification information on the vehicle 20 on which the target part is mounted and the part information on the target part, as the degraded part information, to the store computer 220 at the dealer that sold the automobile 20. The store computer 220 at the dealer extracts refueling stations that were frequently used from among the refueling stations at which the automobile 20 was refueled previously based on information on the refueling stations at which the automobile 20 was refueled previously, and transmits a message that includes information on the extracted refueling stations and that suggests maintenance such as repair or replacement of the part as repair and replacement information to the electronic control unit 30 of the automobile 20. The vehicle user can be informed that the part of the vehicle needs repair or replacement and that such repair or replacement can be performed at refueling stations, by displaying the information on the refueling stations and the message on the display device 70 when the electronic control unit 30 of the automobile 20 receives the repair and replacement information. As a result, it is possible to suggest that the vehicle user should request a refueling station to repair or replace the part during refueling. Moreover, refueling stations that were frequently used by the vehicle user are extracted. Thus, it is possible to suggest that the vehicle user should have the part maintained, e.g., repaired or replaced, during refueling at a refueling station that the vehicle user uses relatively often.

In the vehicle management system 10 according to the embodiment, in addition, the store computer 220 receives a work reservation for repair or replacement of a part at a selected refueling station from the vehicle user, and transmits degraded part information to the refueling station computer 320 at the selected refueling station when the work reservation is received. Consequently, the selected refueling station can be informed of information about the vehicle user and information on the degraded part when the work reservation is received, allowing the part to be maintained, e.g., repaired or replaced, well thereafter. Moreover, a shipping process of shipping the part to the selected refueling station is also performed. Thus, the part related to the work reservation can be shipped smoothly to the selected refueling station.

In the vehicle management system 10 according to the embodiment, further, the store computer 220 transmits a message indicating that refueling and repair or replacement of the part are to be performed at the selected refueling station to the electronic control unit 30 of the automobile 20 when the remaining amount of fuel Qf of the automobile 20 has become less than the notification determination threshold Qref. By the electronic control unit 30 of the automobile 20 displaying such a message on the display device 70, it is possible to suggest that the vehicle user should have the vehicle refueled and have the part repaired or replaced at the selected refueling station. Moreover, the vehicle user can be informed that the part can be repaired or replaced within the time needed for refueling, by using a remaining amount of fuel with which the time required for refueling is longer than the time required to repair or replace the part as the notification determination threshold Qref, suggesting that the vehicle user should have the part repaired or replaced during refueling.

In the vehicle management system 10 according to the embodiment, additionally, when the part is repaired or replaced along with refueling, the refueling station computer 320 calculates a discount on the fuel charge, and outputs a statement including the fuel charge, the discount, and the maintenance fee (charge for the repair or replacement of the part). A discount on the fuel charge can be received by having the part repaired or replaced during refueling in this manner, thereby being able to suggest that the vehicle user should have the degraded part repaired or replaced along with refueling.

When the degraded part information is received, the store computer 220 of the vehicle management system 10 according to the embodiment extracts refueling stations that were frequently used by the vehicle user from among the refueling stations at which the automobile 20 was refueled previously based on information on the refueling stations at which the automobile 20 was refueled previously, and transmits a message that includes information on the extracted refueling stations and that suggests maintenance such as repair or replacement of the part as repair and replacement information to the electronic control unit 30 of the automobile 20. The vehicle user can be informed that the part of the vehicle needs repair or replacement and that such repair or replacement can be performed at refueling stations, by displaying the information on the refueling stations and the message on the display device 70 when the electronic control unit 30 of the automobile 20 receives the repair and replacement information. As a result, it is possible to suggest that the vehicle user should request a refueling station to repair or replace the part during refueling. Moreover, refueling stations that were frequently used by the vehicle user are extracted. Thus, it is possible to suggest that the vehicle user should have the part maintained, e.g., repaired or replaced, during refueling at a refueling station that the vehicle user uses relatively often.

The store computer 220 according to the embodiment receives a work reservation for repair or replacement of the part at a selected refueling station from the vehicle user, and transmits degraded part information to the refueling station computer 320 at the selected refueling station when the work reservation is received. Consequently, the selected refueling station can be informed of information about the vehicle user and information on the degraded part when the work reservation is received, allowing the part to be maintained, e.g., repaired or replaced, well thereafter. Moreover, a shipping process of shipping the part to the selected refueling station is also performed. Thus, the part related to the work reservation can be shipped smoothly to the selected refueling station.

When the remaining amount of fuel Qf of the automobile 20 has become less than the notification determination threshold Qref, the store computer 220 according to the embodiment transmits a message indicating that refueling and repair or replacement of the part are to be performed at the selected refueling station to the electronic control unit 30 of the automobile 20. By the electronic control unit 30 of the automobile 20 displaying such a message on the display device 70, it is possible to suggest that the vehicle user should have the vehicle refueled and have the part repaired or replaced at the selected refueling station. Moreover, the vehicle user can be informed that the part can be repaired or replaced within the time needed for refueling, by using a remaining amount of fuel with which the time required for refueling is longer than the time required to repair or replace the part as the notification determination threshold Qref, suggesting that the vehicle user should have the part repaired or replaced during refueling.

While refueling stations that were frequently used are extracted in the repair etc. notification process by the store computer 220 of the vehicle management system 10 according to the embodiment, refueling stations within the range of a predetermined distance from the home, workplace, etc. of the vehicle user may be extracted.

While a process of shipping the part to the selected refueling station is performed in the reservation reception process by the store computer 220 of the vehicle management system 10 according to the embodiment, such a shipping process may not be performed.

While the store computer 220 of the vehicle management system 10 according to the embodiment performs a notification process, such a notification process may not be performed.

While a discount on the fuel charge is calculated to offer a discount service when the part is repaired or replaced along with refueling in the payment process by the refueling station computer 320 of the vehicle management system 10 according to the embodiment, such a discount service may not be offered.

While the motor MG is attached to the input shaft 23 of the automatic transmission device AT which is connected to the output shaft 21 of the engine EG via the clutch 22 in the automobile 20 according to the embodiment, the vehicle may be a hybrid electric vehicle of any configuration including an engine or an automobile including an engine and a transmission and not including a motor for travel. Alternatively, the vehicle may be a battery electric vehicle or a fuel cell electric vehicle not including an engine or an engine vehicle not including a motor for travel.

The correspondence between the main elements of the embodiment and the main elements of the disclosure described in SUMMARY will be described. In the embodiment, the electronic control unit 30 corresponds to the “vehicle control device”, the management server 120 corresponds to the “management server”, the store computer 220 corresponds to the “store control device”, the vehicle management system 10 corresponds to the “vehicle management system”, and the refueling station computer 320 corresponds to the “supply store control device”.

The correspondence between the main elements of the embodiment and the main elements of the disclosure described in SUMMARY does not limit the elements of the disclosure described in SUMMARY, since the embodiment is an example for specifically describing the mode for carrying out the disclosure described in SUMMARY. That is, the disclosure described in SUMMARY should be construed based on the description in SUMMARY, and the embodiment is merely a specific example of the disclosure described in SUMMARY.

While the mode for carrying out the present disclosure has been described above with reference to the embodiment, an embodiment of the present disclosure is not limited to the embodiment in any way, and may be carried out in various modes without departing from the gist of the present disclosure as a matter of course.

The present disclosure can be used in the manufacturing industry of vehicle management systems etc.

What is claimed is:

1. A vehicle management system comprising:
a vehicle control device configured to communicate via a communication network, the vehicle control device being an in-vehicle vehicle control device;
a management server configured to communicate via the communication network; and
a store control device configured to communicate via the communication network, wherein:
the vehicle control device is configured to transmit vehicle information to the management server at intervals of a predetermined period, the vehicle information including vehicle identification information and vehicle use information about use of a vehicle;
the management server is configured to make a degradation determination for determining a degree of degradation of a part of the vehicle based on the vehicle information received from the vehicle control device, and to transmit degraded part information to the store control device when determination is made in the degradation determination that the part of the vehicle has been degraded to a predetermined degree, the degraded part information including information on the degraded part and the vehicle identification information on the vehicle on which the part is mounted; and
the store control device is configured to transmit repair and replacement information to the vehicle control device when the degraded part information is received from the management server, the repair and replacement information including supply store information and a predetermined message indicating that the degraded part needs repair or replacement, and the supply store information including at least one energy supply store that is able to repair or replace the degraded part and that is able to supply energy for travel to the vehicle on which the degraded part is mounted.

2. The vehicle management system according to claim 1, further comprising a supply store control device disposed at the energy supply store and configured to communicate via the communication network, wherein the store control device is configured to receive a work reservation from a vehicle user, the work reservation including a choice of an energy supply store at which the part is to be repaired or replaced based on the repair and replacement information, and to transmit degraded part information related to the work reservation to the supply store control device at the energy supply store related to the work reservation when the work reservation is received.

3. The vehicle management system according to claim 2, wherein the store control device is configured to perform a process of shipping the part related to the work reservation to the energy supply store related to the work reservation when the work reservation is received.

4. The vehicle management system according to claim 1, wherein:
the vehicle control device is configured to transmit used supply store information about energy supply stores at which the vehicle was supplied with energy for travel previously to the store control device directly or by way of the management server; and
the store control device is configured to specify an energy supply store that was frequently used based on the used supply store information, and to output the repair and replacement information to the specified energy supply store.

5. The vehicle management system according to claim 2, wherein the supply store control device is configured to apply a discounted price when the vehicle is supplied with energy along with repair or replacement of the part related to the work reservation, compared to when the vehicle is supplied with energy without repair or replacement of the part related to the work reservation.

6. The vehicle management system according to claim 1, wherein:
the vehicle control device is configured to transmit remaining amount information about a remaining amount of energy for travel to the store control device directly or by way of the management server; and
the store control device is configured to transmit information to the vehicle control device when the remaining amount of energy has become equal to or less than a predetermined remaining amount based on the remaining amount information, the information including a message that suggests repair or replacement of the degraded part.

7. The vehicle management system according to claim 6, wherein the store control device is configured to transmit information to the vehicle control device when a time needed to supply the vehicle with energy based on the remaining amount information has become equal to or more than a time required to repair or replace the part related to a work reservation, the information including a message that suggests repair or replacement of the degraded part.

8. A vehicle management system comprising:
a vehicle control device configured to communicate via a communication network, the vehicle control device being an in-vehicle vehicle control device;
a management server configured to communicate via the communication network; and
a store control device configured to communicate via the communication network, wherein:
the vehicle control device is configured to transmit vehicle information to the management server at intervals of a predetermined period, the vehicle information including vehicle identification information and vehicle use information about use of a vehicle, and to transmit remaining amount information about a remaining amount of energy for travel to the store control device directly or by way of the management server;
the management server is configured to make a degradation determination for determining a degree of degradation of a part of the vehicle based on the vehicle information received from the vehicle control device, and to transmit degraded part information to the store control device when determination is made in the degradation determination that the part of the vehicle has been degraded to a predetermined degree, the degraded part information including information on the degraded part and the vehicle identification information on the vehicle on which the part is mounted; and
the store control device is configured to transmit repair and replacement information to the vehicle control device when the degraded part information is received from the management server, the repair and replacement information including supply store information and a predetermined message indicating that the degraded part needs repair or replacement, and the supply store information including at least one energy supply store that is able to repair or replace the degraded part and that is able to supply energy for travel to the vehicle on which the degraded part is mounted, the store control device is configured to transmit the repair and replacement information when a time required for energy supply at the energy supply store based on the remaining amount information has become equal to or more than a time required to repair or replace the degraded part.

9. A store control device comprising a communication device configured to communicate with an outside of the store control device via a communication network, wherein the communication device is configured to receive degraded part information from the outside of the store control device, and to transmit repair and replacement information to a vehicle, the repair and replacement information including supply store information and a predetermined message indicating that a degraded part needs repair or replacement, and the supply store information including at least one energy supply store that is able to repair or replace the degraded part and that is able to supply energy for travel to the vehicle on which the degraded part is mounted.

10. The store control device according to claim 9, wherein the store control device is configured to communicate with a vehicle control device and a management server via the communication network, the vehicle control device being an in-vehicle vehicle control device,
the vehicle control device is configured to transmit vehicle information to the management server at intervals of a predetermined period, the vehicle information including vehicle identification information and vehicle use information about use of the vehicle, and
the management server is configured to make a degradation determination for determining a degree of degradation of a part of the vehicle based on the vehicle information, and to transmit degraded part information to the store control device when determination is made in the degradation determination that the part of the vehicle has been degraded to a predetermined degree, the degraded part information including information on the degraded part and the vehicle identification information on the vehicle on which the part is mounted.

11. The store control device according to claim 10, wherein the store control device is configured to communicate with a supply store control device disposed at the energy supply store,
the store control device is configured to receive a work reservation from a vehicle user, the work reservation including a choice of an energy supply store at which the part is to be repaired or replaced based on the repair and replacement information, and to transmit degraded part information related to the work reservation to the supply store control device at the energy supply store related to the work reservation when the work reservation is received.

12. The store control device according to claim 10, wherein:
the vehicle control device is configured to transmit used supply store information about energy supply stores at which the vehicle was supplied with energy for travel previously to the store control device directly or by way of the management server; and
the store control device is configured to specify an energy supply store that was frequently used based on the used supply store information, and to output the repair and replacement information to the specified energy supply store.

13. The store control device according to claim 10, wherein:
the vehicle control device is configured to transmit remaining amount information about a remaining amount of energy for travel to the store control device directly or by way of the management server; and
the store control device is configured to transmit information to the vehicle control device when the remaining amount of energy has become equal to or less than a predetermined remaining amount based on the remaining amount information, the information including a message that suggests repair or replacement of the degraded part.

14. The store control device according to claim 13, wherein the store control device is configured to transmit information to the vehicle control device when a time needed to supply the vehicle with energy based on the remaining amount information has become equal to or more than a time required to repair or replace the part related to a work reservation, the information including a message that suggests repair or replacement of the degraded part.

15. A store control device configured to communicate with a vehicle control device and a management server via a communication network, the vehicle control device being an in-vehicle vehicle control device, the vehicle control device being configured to transmit vehicle information to the management server at intervals of a predetermined period, the vehicle information including vehicle identification information and vehicle use information about use of a vehicle, and to transmit remaining amount information about a remaining amount of energy for travel to the store control device directly or by way of the management server, and the management server being configured to make a degradation determination for determining a degree of degradation of a part of the vehicle based on the vehicle information, and to transmit degraded part information to the store control device when determination is made in the degradation determination that the part of the vehicle has been degraded to a predetermined degree, the degraded part information including information on the degraded part and the vehicle identification information for the part, the store control device comprising a communication device communicable with an outside of the store control device via the communication network, wherein the store control device is configured to transmit repair and replacement information to the vehicle control device when the degraded part information is received and when a time required for energy supply at an energy supply store based on the remaining amount information has become equal to or more than a time required to repair or replace the degraded part, the repair and replacement information including supply store information and a predetermined message indicating that the degraded part needs repair or replacement, and the supply store information including at least one energy supply store that is able to repair or replace the degraded part and that is able to supply energy for travel to the vehicle on which the degraded part is mounted.
